(19) United States
(12) Patent Application Publication
(10) Pub. No.: US 2023/0226489 A1
(43) Pub. Date: Jul. 20, 2023

(54) CATALYTIC OXIDATION OF CARBON BLACK EXHAUST GAS

(71) Applicant: TOPSØE A/S, Kgs. Lyngby (DK)

(72) Inventors: Mads LYKKE, Brønshøj (DK); Gordon R. REYNOLDS, JR., Shrewsbury, MA (US)

(73) Assignee: Topsoe A/S, Kgs. Lyngby (DK)

(21) Appl. No.: 18/000,971

(22) PCT Filed: Jun. 10, 2021
(86) PCT No.: PCT/EP2021/065593

§ 371 Date: Dec. 7, 2022

Related U.S. Application Data
(60) Provisional application No. 63/037,991, filed on Jun. 11, 2020.

(51) Int. Cl. B01D 53/86; B01J 23/22; B01J 23/44; B01J 23/42; B01J 21/16; B01J 21/08; B01J 35/04

(52) U.S. Cl. CPC B01D 53/869; B01D 53/864; B01D 53/8612; B01D 53/8631; B01D 53/8609; B01J 23/22; B01J 23/44; B01J 23/42; B01J 21/16; B01J 21/08; B01J 35/04; B01D 2257/304; B01D 2257/404; B01D 2257/108; B01D 2257/502; B01D 2257/302; B01D 2255/20761; B01D 2255/20769; B01D 2255/2073; B01D 2255/20776; B01D 2255/20738; B01D 2255/20723; B01D 2255/2065; B01D 2258/0283

(57) ABSTRACT

Method for treating a carbon black tail gas wherein the carbon black tail gas is catalytically oxidized to produce an oxidized tail gas. The oxidized tail gas is then treated to remove particulate matter and sulfur oxides. If present, nitrogen oxides can be also removed.

### BACKGROUND

Carbon black is produced by combusting oil or gas under sub-stoichiometric conditions, such that carbon black particulates are produced. The majority of the carbon black particulates is collected by filtering, such that the carbon black product is separated from the exhaust gas rich in carbon black particulates, providing a carbon black tail gas. The tail gas may be rich among others in hydrogen (H₂) and carbon monoxide (CO), as well as other pollutants such as hydrogen sulfide (H₂S), sulfur oxides (SO₂), hydrocarbons, nitrogen oxides (NO and NO₂) and a minor fraction of the carbon black particulates or other carbon-based particulates produced. The emission of these compounds to the atmosphere must be minimized.

Nitrogen oxides may be removed from gas streams by the selective catalytic reduction (SCR) technology in which ammonia or another reductive fuel reacts selectively with NOₓ to form N₂ and water, in the presence of a catalytically active material or the similar non-catalytic reduction (SNCR) technology, which does not require a catalytically active material, but is less specific and requires higher temperatures.

SO₂ may be removed from gas streams by gas scrubbing, which includes dry and wet gas scrubbing. Such methods typically include contacting the gas stream with a dry adsorbent or a liquid scrubbing solution. SO₂ may be removed with high efficiency from gas streams by the wet gas sulfuric acid (WSA® process) technology in which SO₂ is oxidized into SO₃ and in the presence of water subsequently hydrates to H₂SO₄ which may be condensed by cooling in a condenser.

Particulate matter can be reduced or removed from gas streams by various filtration methods. In addition, electrostatic precipitators (ESP) have been used to remove particulates from gas streams, particularly from process gas streams. Use of such ESPs can, however, cause undesired cooling of process gas streams requiring reheating to continue processing which is thermodynamically inefficient and increases processing costs.

Traditionally the carbon black tail gas from carbon black production is combusted in a thermal combustor with the addition of excess atmospheric air, converting hydrogen, and carbon monoxide to water and carbon dioxide and hydrogen sulfide, if present, to sulfur dioxide. Combustion of carbon black tail gas however has the drawback of producing additional nitrogen oxides by thermal oxidation of atmospheric nitrogen.

The carbon black tail gas typically comprises at least 5% hydrogen (H2) and carbon monoxide (CO) in combination, such as at least 2.5% hydrogen (H2) and at least 2.5% carbon monoxide (CO), as well as other pollutants such as hydrogen sulfide (H₂S). The amount of H₂S may be very low, such as 10 ppm, but often it is from 100 ppm to 5000 ppm.

Thus, there is a need in the art for an alternative process for treatment of carbon black tail gas which decreased or avoids the production of additional nitrogen oxides. Further there is a general need in the art for more efficient and more economical methods for treatment of tail gases to meet increasingly strict regulatory requirement. With respect to carbon black processing, there is a need in the art for more efficient and economical methods for removing particulates, nitrogen oxides and sulfur oxides from carbon black process exhaust.

U.S. Pat. No. 9,776,133 reports catalysts for the oxidation of sulfur compounds and a method for oxidation of a species comprising sulfur in an oxidation state below +4, such as H₂S, CS₂, COS and S₈ vapor, to SO₂ as well as catalysts for the oxidation of CO and H₂. The reported method comprises the step of contacting the gas and an oxidant with a catalytically active material consisting of one or more elements from the group consisting of V, W, Ce, Mo, Fe, Ca, Mg, Si, Ti and Al in elemental, oxide, carbide or sulfide form, optionally with the presence of other elements in a concentration below 1 wt % at a temperature between 180° C. and 290° C., 330° C., 360° C., or 450° C. The other elements present may be catalytically active noble metals or impurities in the listed materials. For the oxidation of CO and H₂, these other elements are disclosed to be noble metals, such as Pd or Pt. The process at such temperature is described as highly energy effective. The elements of the catalyst are described as having a low tendency to form sulfates and the catalytically active material is described as having increased stability. This U.S. patent is incorporated by reference herein in its entirety herein for its descriptions of catalysts and methods of use of the described catalysts.

U.S. Pat. No. 10,322,374 reports a process for the removal of soot from a sulfurous gas stream. In the process, a process gas containing O₂ and more than 500 ppm SO, and/or SO₂ together with soot is brought into contact with a VK type catalyst in a reactor. The catalyst is described as comprising vanadium pentoxide (V₂O₅), sulfur in the form of sulfate, pyrosulfate, tri- or tetrasulfate and one or more alkali metals, such as Na, K. Rb or Cs, on a porous carrier, preferably a silicon dioxide carrier. This patent described carbon black as a particular variant of soot and in an embodiment the process is described as applied to carbon black. This U.S. patent is incorporated by reference herein in its entirety, particularly for descriptions of catalysts and the oxidation of soot using such catalysts.

Published PCT application WO 2017/029169, published Feb. 23, 2017, and corresponding published U.S. application 2019/0085168, published Mar. 21, 2019, report systems and methods for reducing particulate matter of an exhaust gas from a carbon black process. These patent documents are incorporated by reference herein in their entirety for descriptions of carbon black processing and processes for removal of particulate matter from carbon black exhaust gas and application of WSA® technology to such exhaust gas.

U.S. Pat. No. 10,493,436 reports a method in which flue gas or exhaust gas containing harmful carbon monoxide, organic compounds (VOC) and NOₓ is contacted with a layered catalyst. A first layer of the catalyst comprises an oxidation catalyst. An underlying layer of catalyst comprises a NH₃—SCR catalyst for the simultaneous removal of the carbon monoxide and NOₓ. This U.S. patent is incorporated by reference herein in its entirety, particularly for descriptions of catalysts which can be employed in the methods and systems of this disclosure.

U.S. Pat. No. 9,192,891 reports methods for control of NO emission in the incineration of tail gas, wherein tail gas comprises NO, NO precursors, or both is introduced into a combustor and diluent is introduced into the combustor for controlling the combustor temperature to a temperature of from about 950° C. to about 1100° C. Methods also are reported for reducing NO emissions by controlling air-to-fuel ratio in a tail gas combustor while controlling the combustor flame temperature through diluent injections. A boiler unit for carrying out these methods also is also reported. A system for carbon black production using the boiler unit also is also reported. This patent also contains discussion of application of treatment techniques for reduction of NO using various chemical or catalytic methods to carbon black tail, including nonselective catalytic reduction (NSCR), selective catalytic reduction (SCR), and selective noncatalytic reduction (SNCR). This patent is incorporated by reference herein in its entirety, particularly for descriptions of carbon black processes and the application of various treatments for the removal or reduction of nitrogen oxides from carbon black tail gas.

A method for treating a carbon black tail gas comprising at least 5% in combination of hydrogen (H₂) and carbon monoxide (CO), as well as other pollutants such as hydrogen sulfide (H₂S), from a process for the production of carbon black, comprising: catalytically oxidizing in the presence of a supported heterogeneous catalyst the carbon black tail gas to thereby produce an oxidized tail gas by converting hydrogen to water, carbon monoxide to carbon dioxide and hydrogen sulfide to sulfur dioxide; and thereafter, removing particulate matter, and sulfur oxides, from the oxidized tail gas.

Alternatively, the present disclosure describes a method for treating a carbon black tail gas from a process for the production of carbon black, comprising: catalytically oxidizing the carbon black tail gas to thereby produce an oxidized tail gas; and thereafter, removing particulate matter, and sulfur oxides, if present, from the oxidized exhaust gas.

In a further embodiment the catalyst used for oxidizing the carbon black tail gas is a catalytically active material comprising one or more elements selected from the group consisting of V, W, Ce, Mo, Fe, Cu or Mn, on a support comprising Ca, Mg, Si, Ti and Al in elemental, oxide, carbide or sulfide form in combination with 0.1 wt % to 1 wt % of a noble metal, preferably Pd or Pt.

In a further embodiment the catalytically active material is in the form of a monolithic catalyst, comprising a structural substrate and a catalyst layer.

In a further embodiment the substrate is made from oxides of Si, Ti, Al, metal, glass fibres, glass paper, cordierite and silicon carbide, alone or in combination.

In a further embodiment the monolithic catalyst has a void volume ranging from 60 vol % to 90 vol %.

In a further embodiment the catalytic oxidation is operated at an average temperature ranging from 250° C. to 600° C., and more preferably at an average temperature ranging from 450° C. to 550° C. and yet more preferably at a temperature ranging from 490° C. to 530° C.

In a further embodiment wherein the oxidation temperature is controlled by combining the carbon black tail gas with a selected amount of a lower heating value gas.

In a further embodiment the lower heating value gas comprises CO₂.

In a further embodiment the lower heat value gas is oxidized tail gas from the carbon black process.

In a further embodiment the oxidized tail gas is obtained by recycling a selected amount of oxidized exhaust gas.

In a further embodiment the ratio of carbon black tail gas to lower heating value gas or oxidized tail gas ranges from 1:2 to 1:20 or from 1:5 to 1:20, or from 1:5 to 1:10.

In a further embodiment the lower heating value gas or the oxidized tail gas is cooled prior to combining with the carbon black tail gas.

In a further embodiment the carbon black tail gas or the oxidized tail exhaust gas is contacted with a catalyst to remove NOₓ by reaction with ammonia or another selective reductant.

In a further embodiment the catalyst to remove NOx is an SCR active catalyst comprising one or more acidic zeolite or zeotype components selected from the group consisting of BEA, MFI, FAU, FER, CHA, MOR or mixtures thereof physically admixed with one or more redox active metal compounds selected from the group consisting of Cu/Al₂O₃, Mn/Al₂O₃, CeO₂—ZrO₂, Ce—Mn/Al₂O₃ and mixtures thereof.

In a further embodiment to remove NOₓ is an SCR active catalyst comprises V₂O₅ optionally in combination with WO₃.

In a further embodiment the oxidized exhaust gas is contacted with a second oxidation catalyst to oxidize carbon black particulates to CO₂ and sulfur oxides, if present, to SO₃.

In a further embodiment the second oxidation catalyst is a catalytically active material comprising vanadium pentoxide (V₂O₅), sulfur in the form of sulfate, pyrosulfate, tri- or tetrasulfate and one or more alkali metals on a porous carrier.

In a further embodiment the porous carrier is a synthetic silicate or geological silicate, such as diatomaceous earth.

In a further embodiment the method further comprises an SO₂ and particulates oxidation step, and the carbon black particulates and SO₂ in the deNOxed tail gas may be oxidized by contact with a catalytically active material comprising vanadium pentoxide (V2O5), sulfur in the form of sulfate, pyrosulfate, tri- or tetrasulfate and one or more alkali metals on a porous carrier, which optionally is a synthetic silicate or geological silicate such as diatomaceous earth, providing oxidized deNOxed exhaust gas, where carbon black particulates are converted to CO₂ and SO₂ (if present) is converted to SO₃ and SO₃ is removed by hydration and condensation of sulfuric acid.

A further aspect of the disclosure relates to a system for production of carbon black which comprises catalytic tail gas oxidation reactor

In a further embodiment the catalytic tail gas oxidation reactor is configured for receiving a carbon black tail gas, rich in hydrogen (H2) and carbon monoxide (CO), as well as other pollutants such as hydrogen sulfide (H2S) and a means for removal of sulfur oxides.

In a further embodiment the system for production of carbon black does not comprise a combustor for said carbon black tail gas.

### DESCRIPTION OF THE DISCLOSURE

The present disclosure provides such an alternative process in which the tail gas is catalytically oxidized in the presence of oxygen, to provide an oxidized tail gas, converting hydrogen to water, carbon monoxide to carbon dioxide and hydrogen sulfide, if present, to sulfur dioxide by catalytic means. This alternative process does not include a step of combustion of the tail gas. Catalytic oxidation of the tail gas is performed at temperatures lower than typical combustion temperature. At such lower temperatures nitrogen oxides are not formed from atmospheric nitrogen, but some oxidation of other nitrogen containing components in the tail gas may occur.

The carbon black tail gas resulting from carbon black processing has a high heating value (HV). This means that oxidation of the carbon black tail gas can result in temperatures harmful to oxidation catalyst. It is therefore beneficial to minimize the temperature increase on catalytic oxidation. This can be done, for example, by dilution of the carbon black tail gas before catalytic oxidation. Such dilution can be done by combination of the carbon black tail gas with a gas having a lower heating value. In addition, it is prudent to consider explosion limits in the oxidized tail gas. This will either require limiting the amount of flammable components or limiting the amount of oxygen. In practice, it is chosen to limit the amount of oxygen to below 1 vol %, to operate safely below the LOC explosion limit.

Both objectives may be achieved by combining the carbon black tail gas with an appropriate dilution gas. In a specific embodiment, the heating value of the carbon black tail gas can be lowered by combining the carbon black tail gas with a lower heating value gas comprising carbon dioxide or a mixture of carbon dioxide and water vapor. The lower heating value gas is optionally cooled prior to combining with the carbon black tail gas, and typically the catalytic oxidation reaction is carried out under substantially adiabatic conditions, such that the outlet gas temperature is significantly above the inlet gas temperature. In a more specific embodiment, the carbon black tail gas can be combined with oxidized exhaust gas. This can be done, for example, by providing a recycle of optionally cooled oxidized exhaust gas to the carbon black tail gas. In an embodiment, the oxidized exhaust gas is cooled to a temperature of 200° C.-390° C., before mixing with the carbon black tail gas. In an embodiment, the heat capacity of the resulting mixture of carbon black tail gas and lower heating value gas is such that when the mixture is directed to the oxidation catalyst, the temperature on oxidation is limited to 600° C. or less, and preferably the catalyst is operated with at a temperature between 320 and 550° C., for example. The ratio of carbon black tail gas to lower heat value gas may range from 1:2 to 1:20 or 1:5 to 1:20 to achieve desired temperatures and dilution of oxygen and flammable constituents.

After catalytic oxidation as described above, the oxidized tail gas will have a much simpler composition, with SO₂, NOₓ and carbon black particulates being the only significant impurities, and therefore the resultant oxidized tail gas may be directed to any known process in which these contaminants are removed. If fuels with little or no sulfur and nitrogen are used, the oxidized exhaust gas may even be sufficiently free of SO₂ and NOₓ, and only require removal of carbon black particulates.

In an embodiment, the disclosure provides a method for treatment of carbon black tail gas from a process for the production of carbon black, comprising catalytically oxidizing the carbon black tail gas to thereby produce an oxidized tail gas; and thereafter, removing particulate matter, and sulfur oxides, if present, from the oxidized exhaust gas. In an embodiment, the method of treatment of carbon black tail gas does not comprise a step of combustion of the carbon black tail gas. In addition various methods for removal of nitrogen oxides, if present, may be applied to carbon black tail gas or oxidized tail gas.

In an embodiment, the disclosure provides a method for production of carbon black wherein tail gas from the carbon black process is subjected to catalytic oxidation rather than combustion to produce an oxidized carbon black tail gas. In an embodiment, the oxidized carbon black tail gas can be further processes to remove particulates (e.g., carbon black particulates) and sulfur oxides if present. In addition various methods for removal of nitrogen oxides, if present, may be applied to carbon black tail gas or oxidized tail gas.

In an embodiment, NOₓ may be removed from either the carbon black tail gas or the oxidized tail gas by the selective catalytic reduction (SCR) technology in which ammonia or another reductive fuel reacts selectively with NOₓ to form N₂ and water, in the presence of certain catalytically active material. As described in at least in U.S. Ser. No. 10/493,436, the catalytically active material used for catalytic oxidation of the carbon black tail gas will typically also be active and well suited for use in the SCR process. In one embodiment, the catalytically active material used in a catalytic tail gas oxidizer may have the dual function of selectively reducing NOₓ (after addition of NH₃ or an ammonia source, e.g. urea) and oxidizing CO and H₂. In a preferred embodiment, NOx is removed from oxidized tail gas. If the NOₓ present in the carbon black tail gas only originates from chemically bound nitrogen in the tail gas and not from oxidation of atmospheric nitrogen, the NOx level may be very low, typically as much as 100 ppmᵥₒₗ lower than if a traditional combustion process is used and thus SCR deNOx may not be required or a significant reduction in the size of the SCR catalyst may be obtained. In an alternative embodiment, the simpler, less expensive, but less quantitative SNCR deNOx process may be sufficient for the purpose of removing the lower amount of NOₓ.

In an embodiment, SO₂ may be removed from oxidized tail gas by the wet gas sulfuric acid (WSA®) technology in which SO₂ is oxidized into SO₃ and in the presence of water subsequently hydrated to H₂SO₄ which may be condensed by cooling in a condenser.

Using catalytic oxidation of carbon black tail gas rather than combustion, it is also possible to obtain quantitative conversion by limiting the amount of oxygen directed to the process. This will have the effect of reducing the process gas volume.

The catalyst used for catalytically oxidizing the tail gas may in an embodiment be a catalyst of the type described in U.S. Pat. No. 9,776,133, i.e. a catalytically active material consisting of one or more elements from the group consisting of V, W, Ce, Mo, Fe, Ca, Mg, Si, Ti and Al in elemental, oxide, carbide or sulfide form, optionally with the presence of other elements in a concentration below 1 wt %, such as 0.01 wt %, 0.02 wt % or 0.05 wt % to 1 wt % of a noble metal, preferably Pd or Pt. The catalytically active material may beneficially be in the form of a monolithic catalyst, comprising a porous carrier. In an embodiment, the catalytically active material may be in the form of a monolithic catalyst comprising silicon carbide or combinations thereof and a catalytic layer. In an embodiment, the monolithic catalyst has a void volume (the volume fraction not taken up by solid material) from 60 vol %, 65 vol % or 70 vol %, to 70 vol %, or 80 vol %. In embodiments, the void volume of the catalyst can range from 60 vol % to 80 vol %, or 65 vol % to 80 vol % or 70 vol % to 80 vol % or 60 vol % to 70 vol %. Catalysts other than those described in U.S. Pat. No. 9,776,133 may also be useful, including catalysts with void volume as high as 90% and catalysts comprising Cu or Mn.

Operating conditions for the catalyst will typically range from 200° C. to 600° C., at ambient pressure. Any known method can be applied for controlling temperature, including staged addition of air in combination with cooling, quenching with water or dilution with a non-reacting gas to provide increased heat capacity of the gas. In a specific embodiment, the temperature of catalytic oxidation is controlled by controlling the heat capacity of the carbon black tail gas that is catalytically oxidized. In an embodiment, the high heating value of the carbon black tail gas is reduced by combining the carbon black tail gas with a gas having a lower heating value. In an embodiment, the gas having the lower heating value is a gas comprising carbon dioxide. In an embodiment, the gas having a lower heating value comprises carbon dioxide and water vapor. In an embodiment, the gas having a lower heating value is at least partially oxidized tail gas from the carbon black process. In an embodiment, the gas having a lower heating value may be obtained by recycling an appropriate amount of oxidized tail gas. In an embodiment, the gas having a lower heating value may be cooled to a selected temperature prior to mixing with the carbon black tail gas. In an embodiment, the gas having a lower heating value may be obtained by recycling an appropriate amount of cooled oxidized tail gas. In embodiments, the lower heating value gas is cooled to a temperature ranging from 100° C. to 200° C. prior to mixing with the carbon black tail gas.

The term “heating value” is used as understood in the art to refer to the amount of heat, in terms of amount of energy per unit mass or volume, that is obtained when a substance, such as a fuel, is combusted. The generic term is used herein to refer to gross heating value (also called higher heating value) as well as net heating value (also called lower heating value). Gross heating value includes heat released on cooling all combustion products to their temperature before combustion and heat released on condensation of water vapor formed on combustion. Net heating value does not include the heat of vaporization of water formed on combustion. Heating values can be measured or calculated or estimated using methods known in the art. It will be appreciated that when comparing heating values of different substances, that the values compared are measured or calculated or estimated in the same way. The term lower heating value gas is used herein to refer to a gas or gas mixture which has a heating value lower than the heating value of a given carbon black process tail gas. It will be appreciated that, the composition and therefore, the heating value of carbon black tail gas may vary dependent upon the grade or type of carbon black being produced and the specific process conditions used for carbon black production.

To the extent required by a presence of NOₓ in the carbon black tail gas or the catalytically oxidized tail gas, a catalyst used for selective catalytic reduction may be provided, to provide a deNOxed tail gas. In an embodiment, NOx may be removed from carbon black tail gas. In an embodiment, NOx may be removed from catalytically oxidized tail gas. In an embodiment, deNOxed tail gas may be catalytically oxidized as described above to produce deNOxed oxidized tail gas.

In an embodiment, carbon black particulates and SO₂ in the oxidized tail gas or the deNOxed oxidized tail gas may be further oxidized by contact with a second more specific oxidation catalyst where carbon black particulates are converted to CO₂ and SO₂, if present is converted to SO₃. The second oxidation catalyst is a catalytically active material comprising vanadium pentoxide (V₂O₅). In an embodiment, the second oxidation catalyst is a catalytically active material comprises vanadium pentoxide, sulfur in the form of sulfate, pyrosulfate, tri- or tetrasulfate and one or more alkali metals on a porous carrier. In an embodiment, the porous carrier for the second catalyst may be a synthetic silicate or geological silicate, such as diatomaceous earth. Tail gas subjected to the two different catalytic oxidation steps herein is designated doubly oxidized tail gas. Tail gas subjected to the deNOx catalyst and the two different catalytic oxidation steps is designated doubly oxidized deNOₓed tail gas.

If the carbon black tail gas comprises sulfur, the doubly oxidized deNOxed tail gas will comprise H₂O and SO₃, which will rapidly react to form sulfuric acid H₂SO₄. In an embodiment, the doubly oxidized deNOxed tail gas is directed to a condenser, in which the treated exhaust gas is cooled below the dew point of sulfuric acid, such that concentrated sulfuric acid is condensed. The condensed sulfuric acid may, if required, be concentrated further to sulfuric acid of added commercial value. The treated exhaust gas leaving the condenser is substantially free of harmful substances.

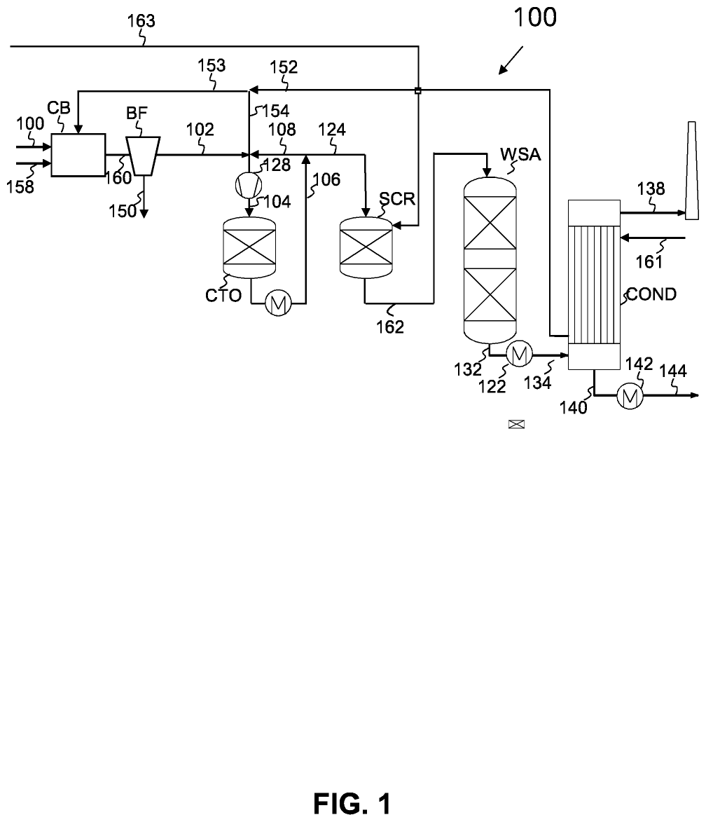

The disclosure further relates to process systems for the treatment of tail gas from carbon black processing. An exemplary system for such treatment is provided in FIG. 1.

### Example 1: Process for Treatment of Tail Gas from Carbon Black Process

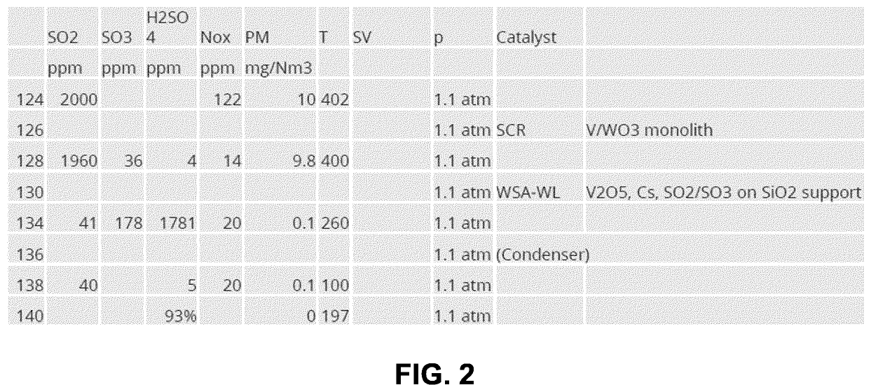

FIG. 1 provides a schematic diagram illustrating an exemplary process for production of carbon black including oxidative treatment of tail gas. FIG. 2 provides a table summarizing example conditions for various steps in the process shown in FIG. 1.

As shown in FIG. 1, the process includes carbon black process (CB), receiving a fuel 100, quench water 158 and preheated air 153 to produce a particulate rich gas 160, which is directed to a bag filter (BF), to generate carbon black product 150 and a carbon black tail gas 102. The carbon black tail gas 102 and a second amount of preheated air 152 is provided to catalytic oxidation reactor CTO via conduit 104 and compressor 128. The catalytic oxidation tail gas oxidation reactor CTO contains an oxidation catalyst operating under conditions providing for oxidation of reduced constituents of the carbon black tail gas 102, such as H₂ and CO. To limit temperature and explosion risk, the oxidized exhaust gas 106 is cooled and an amount is directed as recycle gas 108 to the catalytic tail gas oxidation reactor CTO.

As will be apparent to one having skill in the art a range of approach may be employed in the present methods to prevent combustion in catalytic tail gas oxidation reactor CTO including dilution with the tail gas, addition of lower temperature gases, such as one or more recycle streams, active cooling and any combination of these. In this embodiment, the recycle stream 108 has a volume, amount, flow rate, temperature, etc. so that, upon mixture with the carbon black tail gas 102, the temperature is maintained below combustion conditions. In an embodiment, for example, a rather high amount of a cooled oxidized tail gas is recycled (e.g., recycle:tail gas ratio selected from 8:1 to 10:1, for example a ratio of 9:1 of higher). Use of such a recycle stream may have an implication on the size of equipment, for example, in some embodiments being 10 times or larger as compared to a process/system without recycle.

As shown in FIG. 1, the oxidized tail gas leaves catalytic tail gas oxidation reactor CTO via conduit 124 and may, optionally be subjected to additional processing for example to remove additional components of the tail gas, such as nitrogen oxides, sulfur oxides and particulates. In the embodiment shown in FIG. 1, for example, the oxidized exhaust is subject to treatment using a Selective catalytic reduction (SCR) reactor SCR receiving a stream of ammonia or ammonia-precursor 163, for example, for the removal of nitrogen oxides (NOx) and/or a wet gas sulfuric acid process (WSA) with an SO₂ oxidation reactor, for oxidation of sulfur dioxide (SO₂) to sulfur trioxide (SO₃) and oxidation of carbon particulates to CO₂. Conduit 162 passes deNOXed oxidized tail gas to the wet gas sulfuric acid process (WSA). deNOXed and doubly oxidized tail gas exits WSA via conduit 132. This treated gas is cooled in heat exchanger 122 and directed to a condenser COND via line 134. Before entering the condenser COND, the SO₃ is hydrated to form sulfuric acid H₂SO₄, which condenses as concentrated hot sulfuric acid in 140, is cooled using, for example, cooling water, in acid cooler 142 and withdrawn as commercial grade concentrated sulfuric acid in 144. The condenser is fed with cooling air 161, which is heated and used as preheated air 152, which is split in preheated air 153 for the carbon black process CB and second preheated air 154 for the catalytic tail gas oxidation CTO. The gas product 138 from the condenser COND is clean and may be directed to stack.

In an embodiment, the sections downstream of carbon black product withdrawal do not have a requirement for materials stability at combustion temperatures. Therefore, a benefit of the present processes and systems is that less NOx may present in the oxidized exhaust gas.

### STATEMENTS REGARDING INCORPORATION BY REFERENCE AND VARIATIONS

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference). The following references related to catalytic processes, process conditions and materials which are here by incorporated by reference in their entirety to the extent not inconsistent with the description herein: U.S. Pat. Nos. 10,322,374, 10,493,436, 9,776,133, and US Pub. No. US 2019/0085168.

When a Markush group or other grouping is used herein, all individual members of the group and all combinations and possible subcombinations of the group are intended to be individually included in the disclosure. Every formulation or combination of components described or exemplified herein can be used to practice the invention, unless otherwise stated. Specific names of compounds are intended to be exemplary, as it is known that one of ordinary skill in the art can name the same compounds differently.

One of ordinary skill in the art will appreciate that methods, materials, operating conditions, and device and system elements other than those specifically exemplified can be employed in the practice of the invention without resort to undue experimentation. All art-known functional equivalents of any such methods, materials, operating conditions, device elements and system elements are intended to be included in this invention.

Whenever a range is given in the specification, for example, a composition range, a range of process conditions, a range of pressures or temperatures or the like, all intermediate ranges and subranges, as well as all individual values included in the ranges given are intended to be included in the disclosure. All ranges listed in the disclosure are inclusive of the range endpoints listed.

The invention illustratively described herein suitably may be practiced in the absence of any element or elements, limitation or limitations which is not specifically disclosed herein.

Without wishing to be bound by any particular theory, there can be discussion herein of beliefs or understandings of underlying principles or mechanisms of action relating to the invention. It is recognized that regardless of the ultimate correctness of any mechanistic explanation or hypothesis, an embodiment of the invention can nonetheless be operative and useful.

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention.

1. A method for treating a carbon black tail gas comprising at least 5% in combination of hydrogen (H₂) and carbon monoxide (CO), as well as other pollutants such as hydrogen sulfide (H₂S), from a process for the production of carbon black, comprising the steps of:
catalytically oxidizing the carbon black tail gas in the presence of a supported heterogeneous catalyst to thereby produce an oxidized tail gas; and
thereafter, removing particulate matter, and sulfur oxides, from the oxidized exhaust gas.

2. The method of claim 1, wherein the catalyst used for oxidizing the carbon black tail gas is a catalytically active material comprising one or more elements selected from the group consisting of V, W, Ce, Mo, Fe, Cu or Mn, on a support comprising Ca, Mg, Si, Ti and Al in elemental, oxide, carbide or sulfide form in combination with 0.1 wt % to 1 wt % of a noble metal.

3. The method of claim 2, wherein the catalytically active material is in the form of a monolithic catalyst, comprising a structural substrate and a catalyst layer.

4. The method of claim 3, wherein the substrate is made from oxides of Si, Ti, Al, metal, glass fibres, glass paper, cordierite and silicon carbide, alone or in combination.

5. The method of claim 3, wherein the monolithic catalyst has a void volume ranging from 60 vol % to 90 vol %.

6. The method of claim 1, wherein the catalytic oxidation is operated at an average temperature ranging from 250° C. to 600° C.

7. The method of claim 1, wherein the oxidation temperature is controlled by combining the carbon black tail gas with a selected amount of a lower heating value gas.

8. The method of claim 7, wherein the lower heating value gas is oxidized tail gas from the carbon black process.

9. The method of claim 7, wherein the ratio of carbon black tail gas to the amount of lower heating value gas is from 1:2 to 1:20.

10. The method of claim 1, wherein the carbon black tail gas or the oxidized tail gas is contacted with a catalyst to remove NOx.

11. The method of claim 1, wherein the oxidized exhaust gas is contacted with a second oxidation catalyst to oxidize carbon black particulates to CO₂ and sulfur oxides, to SO₃ wherein the second oxidation catalyst is a catalytically active material comprising vanadium pentoxide (V₂O₅), sulfur in the form of sulfate, pyrosulfate, tri- or tetrasulfate and one or more alkali metals on a porous carrier providing oxidized deNOxed exhaust gas

12. The method of claim 11, wherein carbon black particulates are converted to CO₂ and SO₂ is converted to SO₃ and SO₃ is removed by hydration and condensation of sulfuric acid.

13. A system for production of carbon black which comprises a catalytic tail gas oxidation reactor, configured for receiving a carbon black tail gas, rich in hydrogen (H₂) and carbon monoxide (CO), as well as other pollutants such as hydrogen sulfide (H₂S), and a means for removal of sulfur oxides.

14. The system for production of carbon black of claim 13, which does not comprise a combustor for said carbon black tail gas.

15. The method of claim 2, wherein the noble metal is Pd or Pt.

16. The method of claim 1, wherein the catalytic oxidation is operated at an average temperature ranging from 450° C. to 550° C.

17. The method of claim 1, wherein the catalytic oxidation is operated at an average temperature ranging from 490° C. to 530° C.

18. The method of claim 7, wherein the lower heating value gas is cooled.

19. The method of claim 7, wherein the ratio of carbon black tail gas to the amount of lower heating value gas is from 1:5 to 1:20.

20. The method of claim 7, wherein the ratio of carbon black tail gas to the amount of lower heating value gas is from 1:5 to 1:10.

21. The method of claim 11, wherein the porous carrier is a synthetic silicate or geological silicate such as diatomaceous earth.
